(19) United States
(12) Patent Application Publication
(10) Pub. No.: US 2025/0383591 A1
(43) Pub. Date: Dec. 18, 2025

(54) METHOD FOR MOUNTING SURVEILLANCE CAMERA AND SURVEILLANCE CAMERA

(71) Applicant: i-PRO CO., LTD., Tokyo (JP)

(72) Inventors: Masaya SHITAMI, Tokyo (JP); Koji ABE, Tokyo (JP)

(73) Assignee: i-PRO CO., LTD., Tokyo (JP)

(21) Appl. No.: 19/101,475

(22) PCT Filed: Aug. 2, 2023
(86) PCT No.: PCT/JP2023/028354

§ 371 Date: Feb. 5, 2025

(30) Foreign Application Priority Data
Aug. 8, 2022 (JP) 2022-126397

(51) Int. Cl. G03B 17/56

(52) U.S. Cl. CPC G03B 17/561

(57) ABSTRACT

A method for mounting a surveillance camera includes: attaching a camera body, in which a camera, an installation side case, an enclosure, and a dome cover are integrally assembled, by inserting a fixing screw through a fixing screw through hole formed in the installation side case and screwing the fixing screw into an installation surface; and inserting the dome cover and the enclosure through an inner diameter hole of a cylindrical decorative cover, covering the fixing screw, and attaching the decorative cover to an outer periphery of the camera body

### TECHNICAL FIELD

The present disclosure relates to a method for mounting a surveillance camera and a surveillance camera.

### BACKGROUND ART

In the related art, in the case of a dome type surveillance camera (for example, see Non Patent Literatures 1, 2, and 3), when the camera body is mounted on an installation surface, an operation (a mounting process) according to the following procedure is performed.
(1) A fixing screw fixing an outermost material (for example, a cosmetic cover or a decorative cover) to the camera body is removed, and the outermost material is removed from the camera body, thereby exposing the fixing screw through hole in the installation side case on which the camera is mounted.
(2) A local area network (LAN) cable pulled out from the installation surface is connected to the installation side case.
(3) The installation side case is fixed to the installation surface by inserting the fixing screw through the fixing screw through hole of the installation side case and screwing the fixing screw into the installation surface.
(4) The outermost material is screwed again to the installation side case fixed to the installation surface using the fixing screw to complete the installation.

### CITATION LIST

### Non-Patent Literature

Non Patent Literature 1: Panasonic Connect Co., Ltd., “Optical 21× zoom outdoor PTZ type”, [searched Jul. 19, 2022], Internet <URL: https://connect.panasonic.com/jp-ja/products-services/security_networkcamera/lineup/s6530nj>

Non Patent Literature 2: Panasonic Connect Co., Ltd., “Outdoor dome type”, [searched Jul. 19, 2022], Internet <URL: https://connect.panasonic.com/jp-ja/products-services/security_networkcamera/lineup/wv-s2536lnj>

Non Patent Literature 3: Panasonic Connect Co., Ltd., “Indoor dome type,” [searched Jul. 19, 2022], Internet <URL: https://connect.panasonic.com/jp-ja/products-services/security_networkcamera/lineup/wv-s21361j-s21161>

### SUMMARY OF INVENTION

### Technical Problem

However, the related-art mounting process described above for a dome type surveillance camera requires both a step of removing the fixing screw that fixes the outermost material and a step of screwing the outermost material again to the installation side case fixed to the installation surface using the fixing screw. Therefore, since the preliminary preparation required to fix the installation side case to the installation surface takes time, it is required to reduce the amount of installation work required when installing a surveillance camera. In particular, when the installation surface of the dome type surveillance camera is often a ceiling surface, the installation operation is an upward operation at a high place. Therefore, further simplification of the installation operation is required in order to improve the safety when operating at a high place.

The present disclosure has been made in view of the above-described circumstances in the related art, and provides a method for mounting a surveillance camera and a surveillance camera that can reduce the amount of installation work by reducing a step of removing and mounting a fixing screw to the camera body.

### Solution to Problem

The present disclosure provides a method for mounting a surveillance camera, the method including: a step of attaching a camera body, in which a camera unit, an installation side case, an enclosure, and a dome cover are integrally assembled, by inserting a fixing screw through a fixing screw through hole formed in the installation side case and screwing the fixing screw into an installation surface; and a step of inserting the dome cover and the enclosure through an inner diameter hole of a cylindrical decorative cover, covering the fixing screw, and attaching the decorative cover to an outer periphery of the camera body.

The present disclosure provides a surveillance camera including: a camera unit; a circular installation side case on which the camera unit is mounted at a center and that has a plurality of fixing screw through holes in a circumferential direction through which the fixing screws to be screwed into the installation surface pass; an enclosure that is formed in a cylindrical shape, of which a distal end is provided with a dome cover in a watertight manner, and of which a base end is fixed to the installation side case in a watertight manner with the fixing screw through holes exposed; and a cylindrical decorative cover that is attached to an outer periphery of the installation side case by inserting the dome cover and the enclosure through an inner diameter hole and covering the fixing screw through holes.

### Advantageous Effects of Invention

According to the present disclosure, it is possible to reduce the amount of installation work by reducing a step of removing and mounting a fixing screw to the camera body.

### BRIEF DESCRIPTION OF DRAWINGS

FIG. 1 is a perspective view showing the appearance of a surveillance camera according to an embodiment 1 mounted on an installation surface;

FIG. 2 is a perspective view of the surveillance camera from which a decorative cover is removed;

FIG. 3 is a perspective view of the camera body from which the decorative cover and an enclosure are removed;

FIG. 4 is an exploded perspective view of the surveillance camera as viewed from an installation surface side;

FIG. 5 is a perspective view of the camera body from which the decorative cover is removed;

FIG. 6 is a bottom view of the camera body from which the decorative cover is removed, as viewed from a dome cover side;

FIG. 7 is a top view of the decorative cover as viewed from the installation surface side;

FIG. 8 is a diagram showing a process of attaching the decorative cover to an installation side case;

FIG. 9 is a top view of the surveillance camera in which the decorative cover is engaged with the installation side case and is at the locked position;

FIG. 10 is a cross-sectional view taken along a line A-A in FIG. 9;

FIG. 11 is a diagram showing an indicator portion that is provided across the installation side case and the decorative cover;

FIG. 12 is a diagram showing an operation of fixing the camera body to the installation surface;

FIG. 13 is a diagram showing an operation of positioning the decorative cover on the camera body;

FIG. 14 is a diagram showing an operation of inserting a tongue into a notch;

FIG. 15 is a diagram showing an operation of locking the tongue to an inclined protrusion to engage the decorative cover such that the decorative cover is in a locked state; and

FIG. 16 is a bottom view of the surveillance camera to which the decorative cover is attached.

### DESCRIPTION OF EMBODIMENTS

Hereinafter, an embodiment that specifically discloses a method for mounting a surveillance camera and a surveillance camera according to the present disclosure will be described in detail with reference to the drawings as appropriate. The detailed description more than necessary may be omitted. For example, the detailed description of already well-known matters and the redundant description of substantially the same configuration may be omitted. This is to avoid unnecessary redundancy of the following description and facilitate understanding of a person skilled in the art. The accompanying drawings and the following description are provided for a person skilled in the art to sufficiently understand the present disclosure, and are not intended to limit the subject matter described in the claims.

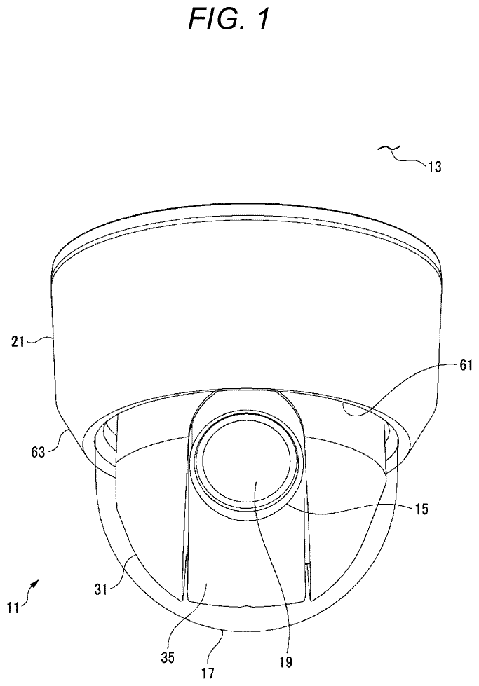

FIG. 1 is a perspective view showing the appearance of a surveillance camera 11 according to an embodiment 1 mounted on an installation surface 13. The surveillance camera 11 according to the embodiment 1 is of a so-called dome type in which a protective cover covering a camera unit 15 is a dome cover 17. The installation body of the dome-shaped surveillance camera 11 is often a ceiling (a ceiling surface). The surveillance camera 11 according to the embodiment 1 will be described taking as an example a case in which the installation surface 13 of the installation body is a ceiling surface. The installation body of the surveillance camera 11 may be a wall surface, a pole, or the like in addition to the ceiling.

The surveillance camera 11 includes a pan rotation drive mechanism (not shown) that pans (rotates horizontally) the camera unit 15, and a tilt rotation drive mechanism (not shown) that tilts (rotates vertically) the camera unit 15. The camera unit 15 is provided with a zoom mechanism (not shown) that changes the focal length by moving a lens 19 along the center of the lens. That is, the surveillance camera 11 according to the embodiment 1 is implemented as a pan tilt zoom (PTZ) camera. In addition, a control board (not shown), a communication interface (not shown), and the like are accommodated in the surveillance camera 11.

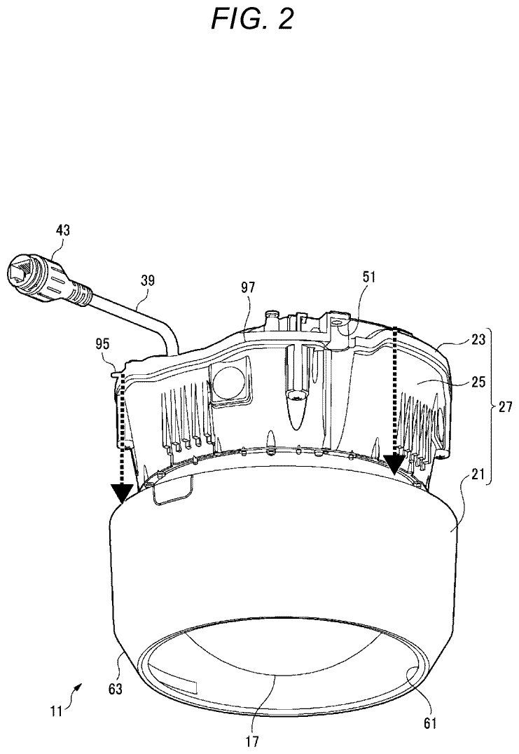

FIG. 2 is a perspective view of the surveillance camera 11 from which a decorative cover 21 is removed. The surveillance camera 11 according to the embodiment 1 includes an installation side case 23, an enclosure 25, and the decorative cover 21. The installation side case 23, the enclosure 25, and the decorative cover 21 constitute a camera body 27 of the surveillance camera 11. In the camera body 27, the decorative cover 21 can be easily attached to and detached from the installation side case 23 and the enclosure 25 without using a fixing screw. When the surveillance camera 11 is packaged for shipping as a product, the decorative cover 21 is attached to the camera body 27 by, for example, a tape, so that the decorative cover 21 can be easily removed when installing.

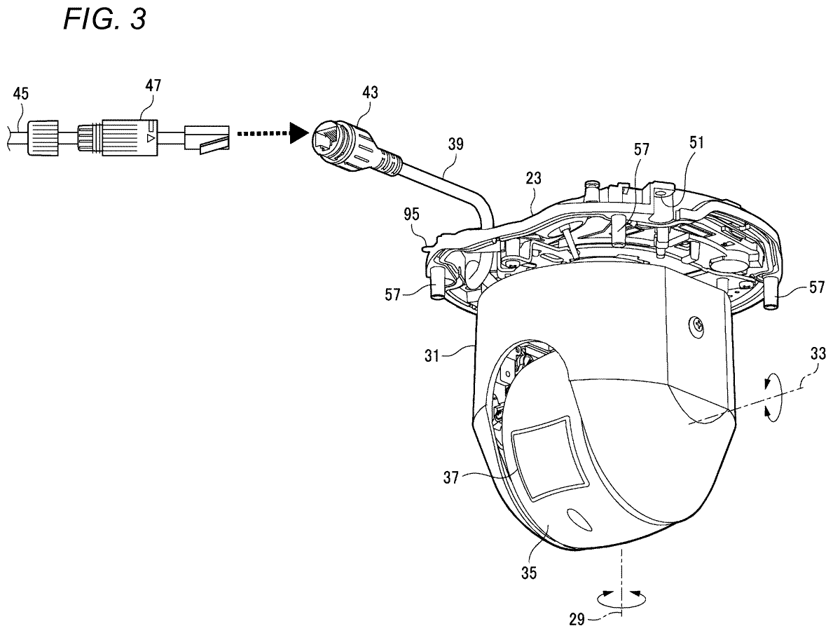

FIG. 3 is a perspective view of the camera body 27 from which the decorative cover 21 and the enclosure 25 are removed. The installation side case 23 is formed in a cylindrical shape with a bottom. The installation side case 23 is formed by, for example, aluminum die casting. The camera unit 15 (see FIG. 1) is mounted at the center of the installation side case 23. The installation side case 23 supports a pan case 31 such that the pan case 31 can freely pan about a pan axis 29 by the pan rotation drive mechanism (see above). The pan case 31 supports a camera case 35 such that the camera case 35 can freely tilt about a tilt axis 33 by the tilt rotation drive mechanism (see above). The camera case 35 accommodates the camera unit 15 therein, and the lens 19 of the camera unit 15 is covered with a front glass 37.

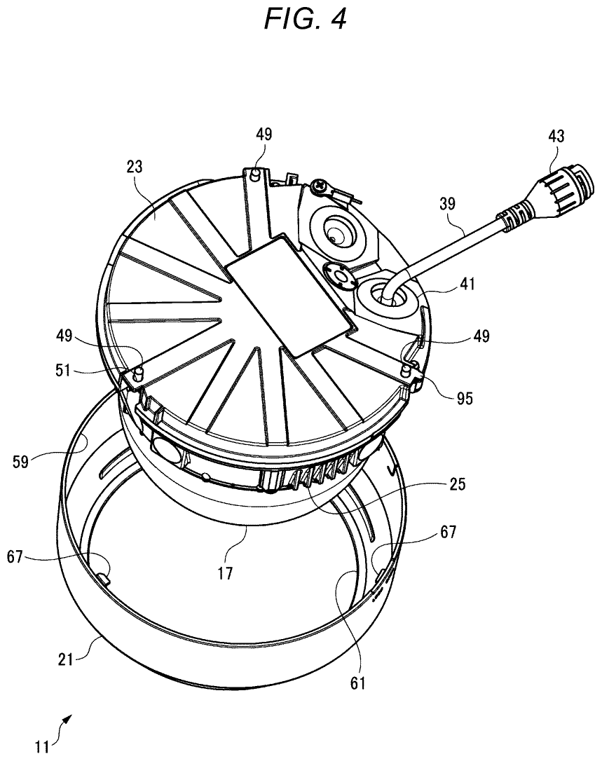

FIG. 4 is an exploded perspective view of the surveillance camera 11 as viewed from an installation surface side. A LAN extension cable 39 is led out in a watertight manner from the surface of the installation side case 23 facing the installation surface 13. The installation side case 23 has a cable insertion hole (not shown) drilled in the surface facing the installation surface 13. The LAN extension cable 39 passes through this cable insertion hole (see above) and is led out to the outside. An annular gap between the LAN extension cable 39 and the cable insertion hole (see above) is sealed with a watertight structure by a grommet 41.

A surveillance camera side connector 43 is attached to the cable end of the LAN extension cable 39. As shown in FIG. 3, a network side connector 47 is attached to a LAN cable 45. The surveillance camera 11 can be easily electrically and physically connected to the LAN cable 45 by coupling the surveillance camera side connector 43 attached to the LAN extension cable 39 to the network side connector 47 of the LAN cable 45.

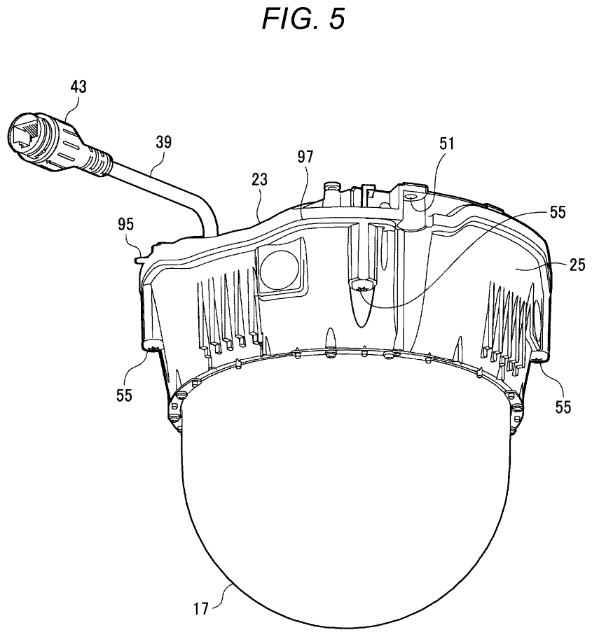

FIG. 5 is a perspective view of the camera body 27 from which the decorative cover 21 is removed. The installation side case 23 has, in the circumferential direction, a plurality of fixing screw through holes 51 through which fixing screws 49 (see FIG. 4) screwed into the installation surface 13 pass. In the embodiment 1, for example, three fixing screw through holes 51 are spaced apart (at substantially equal intervals) in the circumferential direction. The number of the fixing screw through holes 51 may not be limited to three, and the arrangement intervals of the fixing screw through holes 51 may not be limited to substantially equal distances.

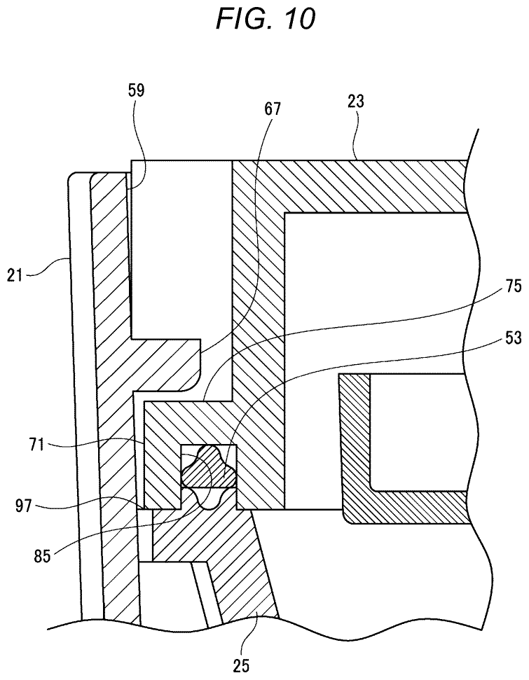

The enclosure 25 is formed in a cylindrical shape, and the dome cover 17 is attached to the distal end (in other words, the vertically downward side as viewed from the ceiling surface) in a watertight manner. The enclosure 25 is fixed in a watertight manner to the installation side case 23 with the base end thereof (in other words, the vertically upper side as viewed from the ceiling surface) exposed to the outside of the fixing screw through hole 51. That is, the installation side case 23 and the enclosure 25 are connected to each other in a watertight structure with an annular packing 53 (see FIG. 10) interposed therebetween.

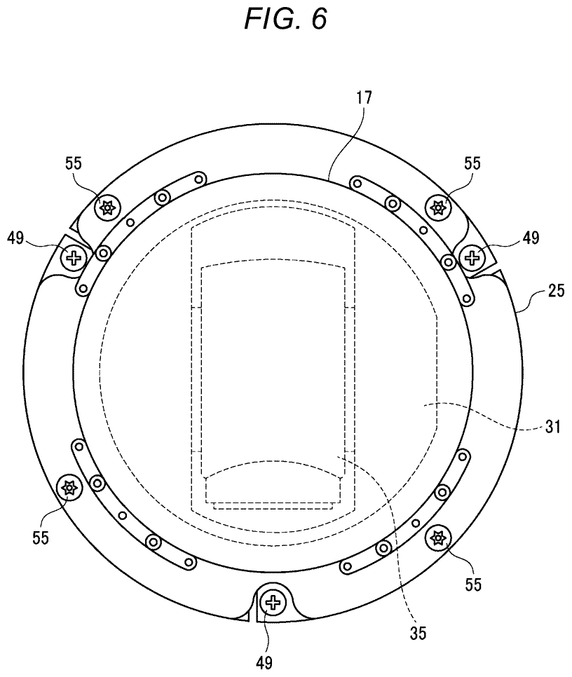

FIG. 6 is a bottom view of the camera body 27 from which the decorative cover 21 is removed, as viewed from a dome cover 17 side. In the embodiment 1, the enclosure 25 is screwed into the installation side case 23 by four enclosure fixing screws 55 provided in the circumferential direction. The enclosure fixing screw 55 is screwed into a fixing shaft portion 57 (see FIG. 3) that stands from the installation side case 23 and that is formed with a female screw. The enclosure fixing screw 55 fastens the enclosure 25 to the installation side case 23 at a position that is farther away from the installation surface 13 than is the fixing screw 49 fixing the installation side case 23 to the installation surface 13.

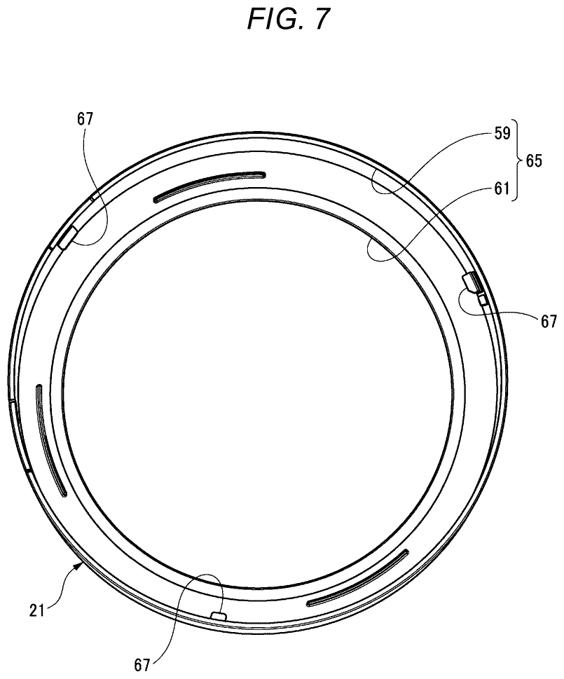

FIG. 7 is a top view of the decorative cover 21 as viewed from the installation surface 13 side. The decorative cover 21 is formed in, for example, a cylindrical shape. In the embodiment 1, the decorative cover 21 is formed in a cylindrical shape of differing diameters with a large diameter hole 59 at the base end thereof (in other words, the vertically upward side as viewed from the ceiling surface) and a small diameter hole 61 at the distal end thereof (in other words, the vertically downward side as viewed from the ceiling surface), and with a tapered surface 63 (see FIG. 2) on the outer peripheral surface. The large diameter hole 59 and the small diameter hole 61 constitute an inner diameter hole 65. The decorative cover 21 is attached to the outer periphery of the installation side case 23 by inserting the dome cover 17 and the enclosure 25 through the inner diameter hole 65 and covering the fixing screw through holes 51 (see FIG. 2). The decorative cover 21 includes a plurality of tongues 67 that protrude toward the center of the inner diameter hole 65 and that are spaced apart in the circumferential direction. In the embodiment 1, three tongues 67 are provided. The number of tongues 67 is not limited thereto.

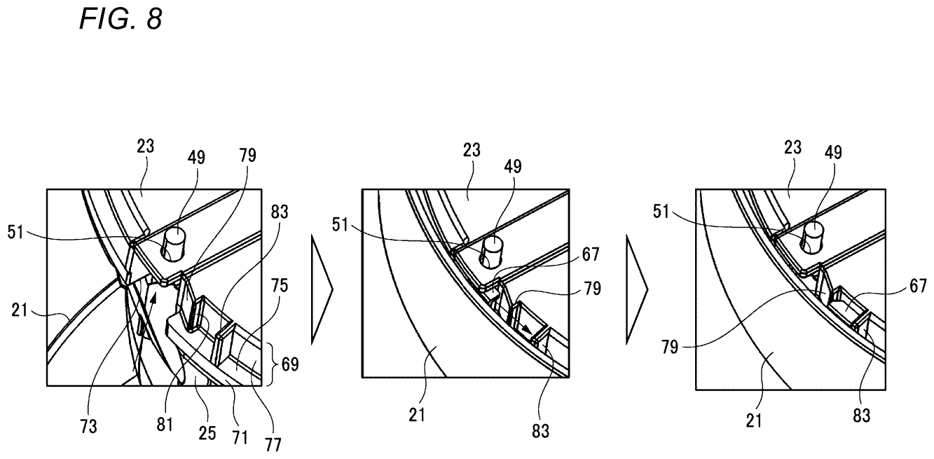

FIG. 8 is a diagram showing a process of attaching the decorative cover 21 to the installation side case 23. The installation side case 23 is provided on the installation surface 13 with a gap 69 therebetween, and includes a flange portion 71 with which the tongue 67 is engaged. That is, when the surface of the installation side case 23 facing the installation surface 13 is fixed to the installation surface 13, the flange portion 71 is provided away from the installation surface 13 by the gap 69. The tongue 67 of the decorative cover 21 enters the gap 69.

The flange portion 71 has a notch 73 through which the fixing screw 49 is inserted and that receives the tongue 67. The tongue 67 inserted into the notch 73 moves into the gap 69 as the decorative cover 21 rotates. The decorative cover 21 is rotated, so that the tongue 67 enters the gap 69 between the installation surface 13 and the flange portion 71, and is placed on an installation surface facing surface 75 of the flange portion 71 by gravity. That is, the tongue 67 is engaged with the flange portion 71 of the installation side case 23 to prevent the decorative cover 21 from falling off.

The installation side case 23 has, on an outer peripheral surface 77 facing the gap 69, an inclined protrusion 79 that gradually protrudes outward in the radial direction toward the rotation direction of the tongue 67. The tongue 67 rides up onto this inclined protrusion 79 as the decorative cover 21 is rotated. The inclined protrusion 79 has a locking surface 81 that extends along the radial direction of rotation at the end in a direction in which the tongue 67 is rotated. A stopper piece 83 is provided on the outer peripheral surface 77 of the installation side case 23 so as to protrude outward in the radial direction of rotation from the locking surface 81 in the moving direction of the tongue 67 at a distance substantially equal to the width of the tongue 67 in the rotation direction of the tongue 67.

When the tongue 67 rides up onto the inclined protrusion 79 and the decorative cover 21 is further rotated, the tongue 67 comes off the end of the inclined protrusion 79, is close to the outer peripheral surface 77, and is locked to the locking surface 81. The tongue 67 locked to the locking surface 81 is restricted from rotating in the reverse direction, and is restricted from rotating in the forward direction by the stopper piece 83. That is, the tongue 67 is restricted from rotating between the inclined protrusion 79 and the stopper piece 83 in the forward and reverse directions. Accordingly, the decorative cover 21 is restricted from rotating, and is brought into an engaged state in which the tongue 67 is placed on the installation surface facing surface 75 of the flange portion 71 by gravity.

The tongue 67 is chamfered at the corner portion facing the locking surface 81. Accordingly, when the decorative cover 21 is rotated in the reverse direction with a force equal to or greater than a certain force, the tongue 67 comes off the locking surface 81 and can move toward the notch 73. When the tongue 67 passes through the inclined protrusion 79 and reaches the notch 73, the decorative cover 21 is disengaged from the installation side case 23. That is, the decorative cover 21 can be attached and detached.

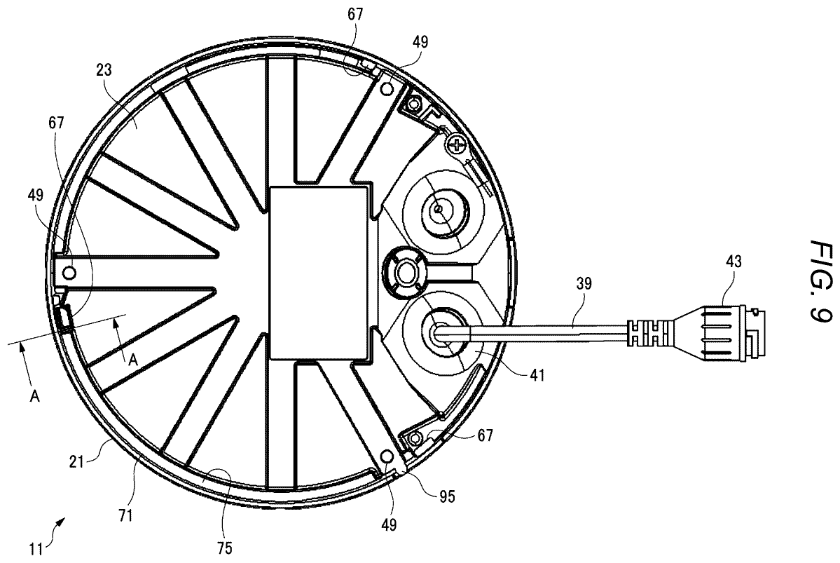

FIG. 9 is a top view of the surveillance camera 11 in which the decorative cover 21 is engaged with the installation side case 23 and is at the locked position. When the tongue 67 is locked to the locking surface 81 of the inclined protrusion 79, the surveillance camera 11 enters a locked state in which the decorative cover 21 is engaged with the installation side case 23. Although three tongues 67 are provided in the embodiment 1, the inclined protrusions 79 may not be provided corresponding to all of the tongues 67. However, in this locked state, all of the tongues 67 are placed on the installation surface facing surface 75 of the flange portion 71 by gravity.

FIG. 10 is a cross-sectional view taken along a line A-A in FIG. 9. The decorative cover 21 is stably engaged with and supported on the installation side case 23 as all of the tongues 67, which are provided at approximately equal intervals in the circumferential direction, are placed on the installation surface facing surface 75 of the flange portion 71. The flange portion 71 has a packing accommodating groove 85 for accommodating the packing 53 on the side opposite to the installation surface facing surface 75. The packing 53 accommodated in the packing accommodating groove 85 seals the space between the installation side case 23 and the enclosure 25 in a watertight manner.

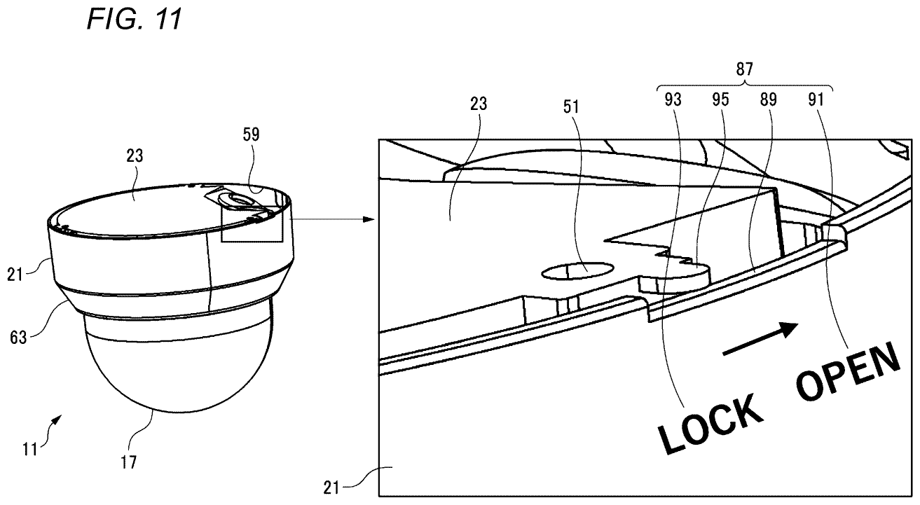

FIG. 11 is a diagram showing an indicator portion 87 that is provided across the installation side case 23 and the decorative cover 21. When the left side of FIG. 11 is the front side of the surveillance camera 11, the indicator portion 87 is provided on the right side as viewed from the front. The indicator portion 87 includes a recess 89 formed at the base end of the decorative cover 21, an OPEN display unit 91, a LOCK display unit 93, and a protrusion 95 that is provided on the installation side case 23 and that is placed in this recess 89. The decorative cover 21 is marked with a display of LOCK on one end side of the recess 89 and a display of OPEN on the other end side of the recess 89. In the decorative cover 21, when the tongue 67 is at a position where the tongue 67 is locked to the inclined protrusion 79, the protrusion 95 becomes the one end side (that is, LOCK) of the recess 89. In the decorative cover 21, when the tongue 67 is at the position of the notch 73, the protrusion 95 becomes the other end side (that is, OPEN) of the recess 89. The decorative cover 21 can be easily mounted and removed using the indicator portion 87 as a guide.

Next, a method for mounting the surveillance camera 11 will be described.

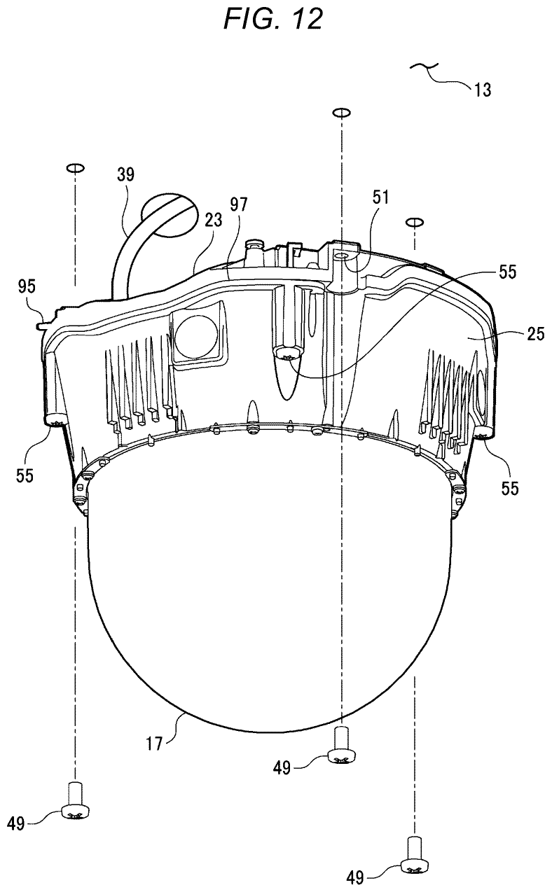

FIG. 12 is a diagram showing an operation of fixing the camera body 27 to the installation surface 13. When the surveillance camera 11 is mounted on the installation surface 13, first, the decorative cover 21 is removed. Before fixing the camera body 27 to the installation surface 13, the surveillance camera 11 connects the LAN extension cable 39 pulled out from the installation side case 23 to the LAN cable 45 pulled out from the cable insertion hole formed in the installation surface 13. Next, the camera body 27 is fixed to the installation surface 13 by inserting the fixing screw 49 through the fixing screw through hole 51 of the installation side case 23 and screwing the fixing screw 49.

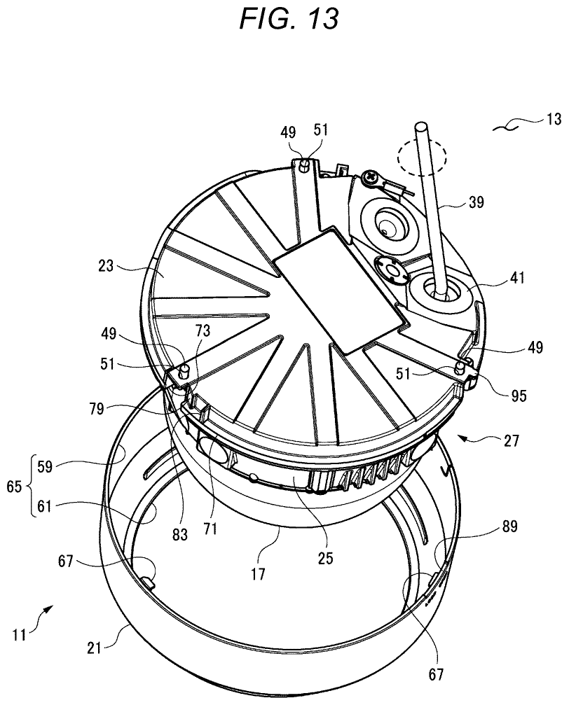

FIG. 13 is a diagram showing an operation of positioning the decorative cover 21 on the camera body 27. Next, the dome cover 17 and the enclosure 25 are inserted through the inner diameter hole 65 of the decorative cover 21. At this time, the decorative cover 21 is positioned such that the recess 89 fits over the protrusion 95.

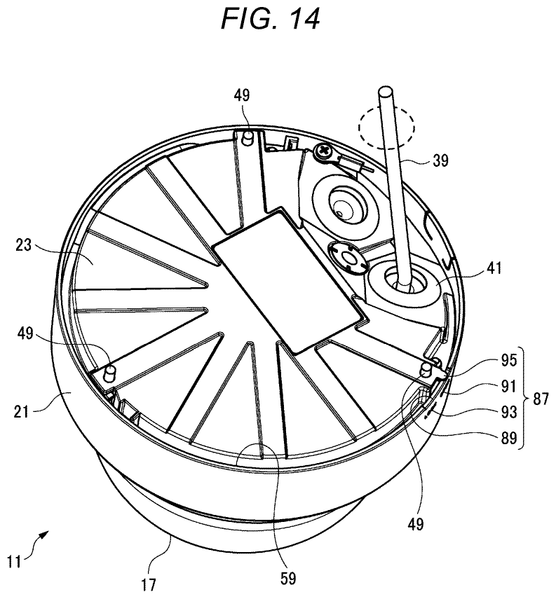

FIG. 14 is a diagram showing an operation of inserting the tongue 67 into the notch 73. More specifically, the decorative cover 21 is inserted by aligning the protrusion 95 with the position of the OPEN display unit 91 of the indicator portion 87. Accordingly, in the decorative cover 21, all of the tongues 67 coincide with the respective notches 73 at the same time.

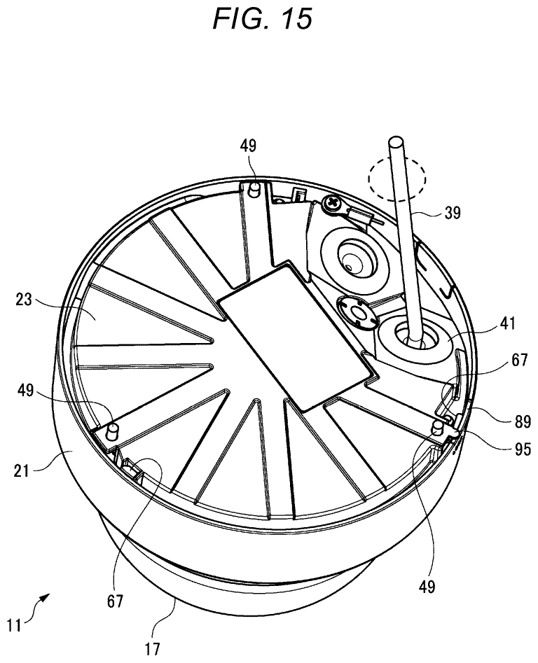

FIG. 15 is a diagram showing an operation of locking the tongue 67 to the inclined protrusion 79 to engage the decorative cover 21 such that the decorative cover 21 is in a locked state. The decorative cover 21 placed on the installation side case 23 rotates counterclockwise as shown in FIG. 15. The protrusion 95 that was provided at the position of the OPEN display unit 91 of the recess 89 is provided at the position of the LOCK display unit 93 of the recess 89. That is, in the method for mounting the surveillance camera 11, after the plurality of tongues 67 protruding from the inner peripheral surface of the inner diameter hole 65 of the decorative cover 21 face the fixing screw 49, the decorative cover 21 is rotated about the axis to engage the tongue 67 with the installation side case 23. Accordingly, the decorative cover 21 enters an engaged state in which the tongue 67 is locked to the inclined protrusion 79, and the attachment to the outer periphery of the camera body 27 is completed.

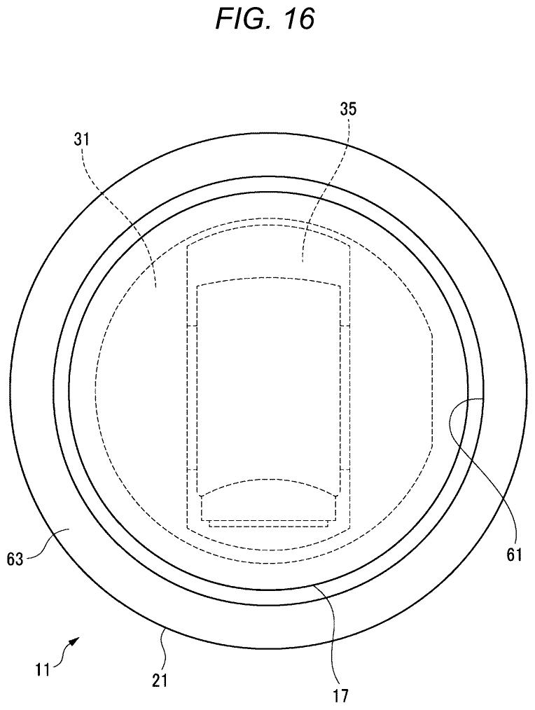

FIG. 16 is a bottom view of the surveillance camera 11 to which the decorative cover 21 is attached. When the attachment of the decorative cover 21 to the surveillance camera 11 is completed, the fixing screw 49 is covered with the decorative cover 21. A connection portion 97 (see FIG. 10) between the installation side case 23 and the enclosure 25 is also covered with the decorative cover 21.

Next, the effects of the above-described configuration will be described.

The method for mounting a surveillance camera according to the embodiment 1 includes a step of attaching the camera body 27, in which the camera unit 15, the installation side case 23, the enclosure 25, and the dome cover 17 are integrally assembled, by inserting the fixing screw 49 through the fixing screw through hole 51 formed in the installation side case 23 and screwing the fixing screw 49 into the installation surface 13, and a step of inserting the dome cover 17 and the enclosure 25 through the inner diameter hole 65 of the cylindrical decorative cover 21, covering the fixing screw 49, and attaching the decorative cover 21 to the outer periphery of the camera body 27.

In the method for mounting a surveillance camera according to the embodiment 1, the mounting of the surveillance camera 11 on the installation surface 13 is completed by the two steps which are the installation surface mounting step and the decorative cover attachment step. That is, when the package accommodating the surveillance camera 11 in a state of being shipped from the factory is opened, the camera body 27 with the decorative cover 21 temporarily fixed with a tape or the like is exposed.

The installation operator or the user removes the decorative cover 21 from the camera body 27 by taking out the camera body 27 to which the decorative cover 21 is temporarily fixed from the package and peeling off the tape.

In the camera body 27 with the decorative cover 21 removed, the camera unit 15, the installation side case 23, the enclosure 25, and the dome cover 17 are integrally assembled. The camera body 27 constitutes an outer shell in which the dome cover 17, the enclosure 25, and the installation side case 23 are assembled in a watertight structure. Inside this outer shell, the camera unit 15, a zoom mechanism, a pan rotation drive mechanism, a tilt rotation drive mechanism, a control board, an interface, and the like are accommodated. The camera body 27 has the plurality of fixing screw through holes 51 formed in the installation side case 23 that abuts against the installation surface 13.

In the installation surface mounting step, the installation side case 23 is fixed to the installation surface 13 by placing the camera body 27 against the attachment position of the installation surface 13 and holding the camera body 27 with one hand, inserting the fixing screws 49 sequentially through the plurality of fixing screw through holes 51, and screwing the fixing screws 49 into the installation surface 13. That is, since the fixing screw through holes 51 are exposed in the camera body 27, there is no need to open the watertight structure between the installation side case 23 and the enclosure 25. Accordingly, the camera body 27 taken out of the package can be fixed to the installation surface 13 in substantially the same state. Since there is no need to open the watertight structure, the product can be provided in the state in which the product passes the airtight inspection at the time of shipment from the factory, and there is no deterioration in the watertight performance.

Next, the decorative cover 21 is attached to the camera body 27 fixed to the installation surface 13 by the decorative cover attachment step.

In the decorative cover attachment step, the dome cover 17 and the enclosure 25 are inserted through the inner diameter hole 65 of the cylindrical decorative cover 21. The cylindrical decorative cover 21 is externally fitted onto the outer periphery of the camera body 27. The decorative cover 21 externally fitted onto the outer periphery of the camera body 27 is attached to the outer periphery of the camera body 27 in a state in which the decorative cover 21 covers the fixing screw 49 fixing the installation side case 23 to the installation surface 13. This attachment can be performed without screwing the fixing screw 49. Accordingly, mounting of the surveillance camera 11 on the installation surface 13 is completed.

In this method for mounting a surveillance camera, the operation required in the related-art mounting method of removing the outermost material by removing the fixing screws 49 from the surveillance camera 11 taken out of the package and the operation of screwing the outermost material again with the fixing screws 49 to the camera body 27 fixed to the installation surface 13 are no longer necessary. More specifically, the related-art operation of removing the outermost material by removing the fixing screws 49 can be replaced with a simple operation of removing the outermost material by peeling off the tape. The related-art operation of screwing the outermost material to the camera body 27 fixed to the installation surface 13 with the fixing screws 49 can be replaced with a simple operation of inserting the dome cover 17 and the enclosure 25 through the inner diameter hole 65 of the decorative cover 21 and rotating the decorative cover 21 to engage the decorative cover 21 with the outer periphery of the camera body 27 and attach the decorative cover 21.

Accordingly, the amount of operation work required for both the preliminary preparation and the installation operation can be reduced, and as a result, the amount of installation work required when performing installation can be reduced. In the dome type surveillance camera 11, since the installation surface 13 is often a ceiling surface, the installation operation is an upward operation at a high place. Therefore, the installation operation is simplified and the amount of installation work is reduced, so that the safety of the operation at a high place can be improved. In particular, when the surveillance camera 11 is a PTZ camera, the weight of the camera body 27 (excluding the decorative cover 21) including the installation side case 23 and the enclosure 25 tends to be larger than that of a normal fixed camera due to inclusion of the pan rotation drive mechanism (not shown) and the tilt rotation drive mechanism (not shown). Therefore, since it is preferable to complete mounting in as short a time as possible and the safety of the operation at a high place is further demanded, the effect of reducing the number of mounting steps is more pronounced when using a PTZ camera. Accordingly, according to the method for mounting a surveillance camera and the surveillance camera 11 in the embodiment 1, the amount of installation work can be reduced by reducing a step of removing and mounting the fixing screw 49 to the camera body 27.

In the method for mounting a surveillance camera, in order to attach the decorative cover 21, after the plurality of tongues 67 protruding from the inner peripheral surface of the inner diameter hole 65 of the decorative cover 21 face the fixing screw 49, the decorative cover 21 is rotated about the axis to engage the tongues 67 with the installation side case 23.

In the method for mounting a surveillance camera, the decorative cover 21 is attached to the camera body 27 fixed to the installation surface 13 by rotating the decorative cover 21. That is, the decorative cover 21 is provided with the plurality of tongues 67 protruding from the inner peripheral surface of the inner diameter hole 65.

On the other hand, in the installation side case 23 of the camera body 27, the notch 73 for exposing the fixing screw through hole 51 is formed in the flange portion 71. Therefore, the fixing screw 49 is inserted through the fixing screw through hole 51 from the notch 73.

The tongue 67 provided on the decorative cover 21 is inserted into the notch 73 similarly to the fixing screw 49 toward the fixing screw 49 fixing the installation side case 23. The flange portion 71 has the gap 69 from the installation surface 13. The decorative cover 21 is rotated, so that the tongue 67 inserted into the notch 73 enters the gap 69 between the installation surface 13 and the flange portion 71, and is placed on the installation surface facing surface 75 of the flange portion 71 by gravity. That is, the tongue 67 is engaged with the flange portion 71 to prevent the decorative cover 21 from falling off.

In the method for mounting a surveillance camera, the decorative cover 21 can be easily attached to the camera body 27 by inserting the tongue 67 into the notch 73 of the flange portion 71 and rotating the decorative cover 21 while passing the dome cover 17 and the enclosure 25 through the inner diameter hole 65 of the decorative cover 21, eliminating the need to screw the outermost material (the decorative cover 21) again with the fixing screw 49.

In the method for mounting a surveillance camera, before fixing the camera body 27 to the installation surface 13, the LAN extension cable 39 pulled out from the installation side case 23 is connected to the LAN cable 45 pulled out from the cable insertion hole formed in the installation surface 13.

In the method for mounting a surveillance camera, the LAN extension cable 39 is connected to the LAN cable 45 before the camera body 27 is fixed to the installation surface 13. Accordingly, in the method for mounting a surveillance camera, since there is no need to open the watertight structure between the installation side case 23 and the enclosure 25, the product can be provided in the state in which the product passes the airtight inspection at the time of shipment from the factory, and there is no deterioration in the watertight performance.

The surveillance camera 11 according to the embodiment 1 includes: the camera unit 15; the circular installation side case 23 on which the camera unit 15 is mounted at a center and that has the plurality of fixing screw through holes 51 in a circumferential direction through which the fixing screws 49 to be screwed into the installation surface 13 pass; the enclosure 25 that is formed in a cylindrical shape, of which a distal end is provided with the dome cover 17 in a watertight manner, and of which a base end is fixed to the installation side case 23 in a watertight manner with the fixing screw through holes 51 exposed; and the cylindrical decorative cover 21 that is attached to an outer periphery of the installation side case 23 by inserting the dome cover 17 and the enclosure 25 through the inner diameter hole 65 and covering the fixing screw through holes 51.

In the surveillance camera 11 according to the embodiment 1, the camera unit 15 is accommodated inside the camera body 27 sealed with a watertight structure. The installation side case 23 and the enclosure 25 are connected in a watertight manner to form an accommodation space in the camera body 27. The dome cover 17 is attached to the enclosure 25 in a watertight manner. That is, the installation side case 23, the enclosure 25, and the dome cover 17 constitute the outer shell of the surveillance camera 11.

The camera body 27 exposes the plurality of fixing screw through holes 51 formed in the installation side case 23. That is, the camera body 27 can be fixed to the installation surface 13 by the fixing screw 49 inserted through the fixing screw through hole 51 without opening the outer shell.

The cylindrical decorative cover 21 is attached to the camera body 27. The decorative cover 21 is attached to the outer periphery of the installation side case 23 by inserting the dome cover 17 and the enclosure 25 through the inner diameter hole 65 and covering the fixing screw through holes 51. This attachment does not require screwing of the fixing screw 49. Accordingly, the surveillance camera 11 can be mounted on the installation surface 13 rapidly.

The decorative cover 21 is attached to the surveillance camera 11, so that the connection portion 97 connecting the installation side case 23 and the enclosure 25 with a watertight structure is covered with the decorative cover 21. Accordingly, the surveillance camera 11 can prevent the high-pressure jet water from directly hitting the connection portion 97, thereby improving the waterproof property.

When the surveillance camera 11 is mounted on the installation surface 13, the operation of removing the decorative cover 21 by removing the fixing screws 49 from the surveillance camera 11 and the operation of screwing the decorative cover 21 again with the fixing screws 49 to the camera body 27 fixed to the installation surface 13 are no longer necessary.

Accordingly, the amount of operation work required for both the preliminary preparation and the installation operation can be reduced, and as a result, the amount of installation work required when performing installation can be reduced. In the dome type surveillance camera 11, since the installation surface 13 is often a ceiling surface, the installation operation is an upward operation at a high place. Therefore, the installation operation is simplified and the amount of installation work is reduced, so that the safety of the operation at a high place can be improved.

In the surveillance camera 11, the decorative cover 21 includes the plurality of tongues 67 protruding into the inner diameter hole 65 so as to be spaced apart in a circumferential direction, the installation side case 23 includes the flange portion 71 that has the gap 69 from the installation surface 13 and with which the tongues 67 is engaged, and the flange portion 71 has the notch 73 through which the fixing screw 49 is inserted, that receives the tongues 67, and that engages the tongues 67 moved to the gap 69 by rotation of the decorative cover 21 with the flange portion 71.

In surveillance camera 11, the decorative cover 21 is attached to the camera body 27 fixed to the installation surface 13 by rotating the decorative cover 21. That is, the decorative cover 21 is provided with the plurality of tongues 67 protruding from the inner peripheral surface of the inner diameter hole 65.

On the other hand, in the installation side case 23 of the camera body 27, the notch 73 for exposing the fixing screw through hole 51 is formed in the flange portion 71. Therefore, the fixing screw 49 is inserted through the fixing screw through hole 51 from the notch 73.

The tongue 67 provided on the decorative cover 21 is inserted into the notch 73 similarly to the fixing screw 49 toward the fixing screw 49 fixing the installation side case 23. The flange portion 71 has the gap 69 from the installation surface 13. The decorative cover 21 is rotated, so that the tongue 67 inserted into the notch 73 enters the gap 69 between the installation surface 13 and the flange portion 71, and is placed on the installation surface facing surface 75 of the flange portion 71 by gravity. That is, the tongue 67 is engaged with the flange portion 71 to prevent the decorative cover 21 from falling off.

In the surveillance camera 11, the decorative cover 21 can be easily attached to the camera body 27 by inserting the tongue 67 into the notch 73 of the flange portion 71 and rotating the decorative cover 21 while passing the dome cover 17 and the enclosure 25 through the inner diameter hole 65 of the decorative cover 21, eliminating the need to screw the outermost material (the decorative cover 21) again with the fixing screw 49.

In the camera body 27 in which the decorative cover 21 is mounted on the outer periphery, the connection portion 97 that extends in the circumferential direction of the installation side case 23 and the enclosure 25 connected to each other with the waterproof packing or the like interposed therebetween is covered with the cylindrical decorative cover 21. Accordingly, it is possible to prevent the high-pressure jet water from directly hitting the connection portion 97, thereby improving the waterproof property.

In the surveillance camera 11, the LAN extension cable 39 is led out in a watertight manner from the surface of the installation side case 23 facing the installation surface 13.

In the surveillance camera 11, the LAN extension cable 39 is led out in the watertight manner from a surface of the installation side case 23 facing the installation surface 13. The surveillance camera side connector 43 is attached to the cable end of the LAN extension cable 39. The network side connector 47 is attached to the LAN cable 45.

The surveillance camera 11 can be easily connected to the LAN cable 45 by coupling the surveillance camera side connector 43 attached to the LAN extension cable 39 to the network side connector 47 of the LAN cable 45.

Accordingly, in the surveillance camera 11, since there is no need to open the watertight structure between the installation side case 23 and the enclosure 25, the product can be provided in the state in which the product passes the airtight inspection at the time of shipment from the factory, and can be provided while maintaining high watertight performance.

Although various embodiments have been described above with reference to the accompanying drawings, the present disclosure is not limited to such examples. It is apparent to a person skilled in the art that various changes, corrections, substitutions, additions, deletions, and equivalents can be conceived within the scope of the claims, and it is understood that such modifications also belong to the technical scope of the present disclosure. The components in the various embodiments described above may be freely combined without departing from the gist of the invention.

For example, in the configuration example described above, the installation side case is directly fixed to the installation surface. Alternatively, the installation side case may of course be fixed to the installation body via an attachment metal fitting, a switch box, or the like. In the configuration example described above, the surveillance camera has been described taking the PTZ type as an example. Alternatively, the surveillance camera may be of a fixed type in which the angle of view is manually adjusted.

The present application is based on Japanese Patent Application (Japanese Patent Application No. 2022-126397) filed on Aug. 8, 2022, and the contents thereof are incorporated herein by reference.

### INDUSTRIAL APPLICABILITY

The present disclosure is useful as a method for mounting a surveillance camera and a surveillance camera that can reduce the amount of installation work by reducing a step of removing and mounting a fixing screw to the camera body.

### REFERENCE SIGNS LIST

11: surveillance camera
13: installation surface
15: camera unit
17: dome cover
21: decorative cover
23: installation side case
25: enclosure
27: camera body
39: LAN extension cable
45: LAN cable
49: fixing screw
51: fixing screw through hole
65: inner diameter hole
67: tongue
69: gap
71: flange portion
73: notch

1. A method for mounting a surveillance camera, the method comprising:
attaching a camera body, in which a camera unit, an installation side case, an enclosure, and a dome cover are integrally assembled, to an installation surface by inserting a fixing screw through a fixing screw through hole formed in the installation side case and screwing the fixing screw into the installation surface; and
inserting the dome cover and the enclosure through an inner diameter hole of a cylindrical decorative cover, covering the fixing screw, and attaching the decorative cover to an outer periphery of the camera body.

2. The method for mounting a surveillance camera according to claim 1, wherein
in the attaching the decorative cover, after a plurality of tongues protruding from an inner peripheral surface of the inner diameter hole of the decorative cover face the fixing screw, the decorative cover is rotated about an axis to engage the tongues with the installation side case.

3. The method for mounting a surveillance camera according to claim 1, wherein
before fixing the camera body to the installation surface, a LAN extension cable pulled out from the installation side case is connected to a LAN cable pulled out from a cable insertion hole formed in the installation surface.

4. A surveillance camera comprising:
a camera unit;
a circular installation side case on which the camera unit is mounted at a center and that has a plurality of fixing screw through holes in a circumferential direction through which the fixing screws to be screwed into the installation surface pass;
an enclosure that is formed in a cylindrical shape, of which a distal end is provided with a dome cover in a watertight manner, and of which a base end is fixed to the installation side case in a watertight manner with the fixing screw through holes exposed; and
a cylindrical decorative cover that is attached to an outer periphery of the installation side case by inserting the dome cover and the enclosure through an inner diameter hole and covering the fixing screw through holes.

5. The surveillance camera according to claim 4, wherein
the decorative cover includes a plurality of tongues protruding into the inner diameter hole so as to be spaced apart in a circumferential direction,
the installation side case includes a flange portion that has a gap from the installation surface and with which the tongues are engaged, and
the flange portion has a notch through which the fixing screw is inserted, that receives the tongues, and that engages the tongues moved to the gap by rotation of the decorative cover.

6. The surveillance camera according to claim 4, wherein
the LAN extension cable is led out in a watertight manner from a surface of the installation side case, the surface facing the installation surface.
